(19) United States
(12) Patent Application Publication
(10) Pub. No.: US 2025/0309349 A1
(43) Pub. Date: Oct. 2, 2025

(54) ELECTROLYTE FOR LITHIUM SECONDARY BATTERY AND LITHIUM SECONDARY BATTERY INCLUDING THE SAME

(71) Applicants: SK ON CO., LTD., Seoul (KR); SK INNOVATION CO., LTD., Seoul (KR)

(72) Inventors: Yu Na Shim, Daejeon (KR); Jeong Yun KIM, Daejeon (KR); Hong Won LEE, Daejeon (KR); Jeong Hoon YOON, Daejeon (KR); Min Joung IM, Daejeon (KR); Dong Il JANG, Daejeon (KR); Yong Nam JOE, Daejeon (KR); In Haeng CHO, Daejeon (KR)

(21) Appl. No.: 19/089,019

(22) Filed: Mar. 25, 2025

(30) Foreign Application Priority Data
Mar. 28, 2024 (KR) 10-2024-0042189

(51) Int. Cl. H01M 10/0567; H01M 10/0525; H01M 10/42

(52) U.S. Cl. CPC H01M 10/0567; H01M 10/0525; H01M 10/4235; H01M 2300/0037

(57) ABSTRACT

An electrolyte for a lithium secondary battery according to the embodiments of the present disclosure includes a lithium salt, an organic solvent, a phosphate-based additive including a compound represented by the following Formula 1, and a halogenated benzene. A lithium secondary battery including the electrolyte and having improved flame retardancy and high-temperature stability of the electrolyte, as well as improved high-temperature lifespan characteristics and high-temperature storage characteristics may be provided.

### CROSS-REFERENCE TO RELATED APPLICATION

This patent application claims the priority and benefits of Korean patent application No. 10-2024-0042189, filed on Mar. 28, 2024, the disclosure of which is incorporated herein by reference in its entirety.

### BACKGROUND

### 1. Field of the Invention

The present disclosure relates to an electrolyte for a lithium secondary battery and a lithium secondary battery including the same, and more specifically, to an electrolyte for a lithium secondary battery which includes an additive and a lithium secondary battery including the electrolyte.

### 2. Description of the Related Art

A secondary battery is a battery which can be repeatedly charged and discharged. With rapid progress of information and communication, and display industries, the secondary battery has been widely applied to various portable electronic telecommunication devices such as a camcorder, a mobile phone, a laptop computer as a power source thereof. Recently, a battery pack including the secondary battery has also been developed and applied to an eco-friendly automobile such as a hybrid vehicle as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight, such that development thereof has been proceeded in this regard.

For example, the lithium secondary battery may include: an electrode assembly including a cathode, an anode, and a separation membrane (separator); and an electrolyte in which the electrode assembly is impregnated. The lithium secondary battery may further include, for example, a pouch-shaped outer case in which the electrode assembly and the electrolyte are housed.

A lithium secondary battery having longer lifespan, high capacity, and operational stability is required as the application range thereof is expanded. Accordingly, a lithium secondary battery that provides uniform output and capacity even during repeated charging and discharging is preferable.

However, according to the repeated charging and discharging, the output and capacity may be decreased due to damage to the surface of the nickel-based lithium metal oxide used as a cathode active material, and a side reaction between the nickel-based lithium metal oxide and the electrolyte may occur. In addition, stability of the battery may be deteriorated in a severe high temperature or low temperature environment.

### SUMMARY

An object of the present disclosure is to provide an electrolyte for a lithium secondary battery which provides improved high-temperature stability and lifespan characteristics.

Another object of the present disclosure is to provide a lithium secondary battery which includes the electrolyte and has improved high-temperature stability and lifespan characteristics.

To achieve the above objects, according to an aspect of the present disclosure, there is provided an electrolyte for a lithium secondary battery including: a lithium salt, an organic solvent, a phosphate-based additive which comprises a compound represented by Formula 1 below, and halogenated benzene:

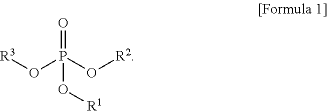

In Formula 1 above, R¹ to R³ may each independently be a C6 to C18 aryl group, a C6 to C18 halogenated aryl group, a C1 to C10 alkyl group, a C1 to C10 halogenated alkyl group, or a C2 to C10 alkenyl group, and when at least one of R¹ to R³ is a C6 to C18 aryl group, at least one of R¹ and R² may not be the same as R³.

According to exemplary embodiments, in Formula 1 above, R¹ and R² may each independently be a C6 to C18 aryl group, a C6 to C18 halogenated aryl group, or a C1 to C5 halogenated alkyl group, and R³ may be a C6 to C18 halogenated aryl group or a C1 to C5 halogenated alkyl group.

According to exemplary embodiments, the phosphate-based additive may include at least one selected from the group consisting of tris(2,2,2-trifluoroethyl) phosphate, tris(3,3,3-trifluoropropyl) phosphate, bis(2,2,2-trifluoroethyl) (3,3,3-trifluoropropyl) phosphate, diphenyl(2,2,2-trifluoroethyl) phosphate, and bis(2,2,2-trifluoroethyl) phenyl phosphate.

According to exemplary embodiments, the aryl group of C6 to C18 may include a phenyl group, a naphthyl group or an anthracene group.

According to exemplary embodiments, a content of the phosphate-based additive may be 1% by weight to 15% by weight based on a total weight of the electrolyte.

According to exemplary embodiments, the halogenated benzene may include 1 to 6 fluorine atoms bonded to a benzene ring.

According to exemplary embodiments, the halogenated benzene may include at least one selected from the group consisting of fluorobenzene, difluorobenzene and trifluorobenzene.

According to exemplary embodiments, a content of the halogenated benzene may be 1% by weight to 20% by weight based on the total weight of the electrolyte.

According to exemplary embodiments, a ratio of the content of the halogenated benzene to the content of the phosphate-based additive in the total weight of the electrolyte may be 0.5 to 4.

According to exemplary embodiments, a ratio of the content of the halogenated benzene to the content of the phosphate-based additive in the total weight of the electrolyte may be 1 to 3.

According to exemplary embodiments, the electrolyte may further include at least one auxiliary additive selected from the group consisting of a cyclic carbonate compound, a fluorine-substituted cyclic carbonate compound, a sultone compound, a cyclic sulfate compound, a fluorine-substituted phosphate compound, and an oxalato phosphate compound.

According to exemplary embodiments, the content of the auxiliary additive may be 0.01% by weight to 5% by weight based on the total weight of the electrolyte.

According to another aspect of the present invention, there is provided a lithium secondary battery including: a case; an electrode assembly which is housed in the case and comprises a cathode and an anode disposed to face the cathode; and the electrolyte for a lithium secondary battery housed in the case together with the electrode assembly.

The electrolyte for a lithium secondary battery according to exemplary embodiments of the present disclosure may include a phosphate-based additive. Accordingly, flame retardancy of the electrolyte may be improved.

In addition, the electrolyte for a lithium secondary battery according to exemplary embodiments of the present disclosure may include halogenated benzene. Accordingly, the flame retardancy of the electrolyte may be further improved, and a decrease in cell performance may be suppressed by the phosphate-based additive.

The electrolyte for a lithium secondary battery according to exemplary embodiments of the present disclosure may include the phosphate-based additive and the halogenated benzene in a predetermined ratio of contents. Accordingly, high-temperature storage characteristics and high-temperature lifespan characteristics of the lithium secondary battery including the electrolyte may be further improved.

The lithium secondary battery according to exemplary embodiments of the present disclosure may include the electrolyte. Accordingly, heat resistance characteristics of the battery may be improved, such that even if the battery is exposed to a high-temperature environment, ignition may be delayed and thermal stability may be improved.

In addition, the lithium secondary battery according to exemplary embodiments of the present disclosure may have improved cell performance such as capacity and resistance. The lithium secondary battery may maintain its cell performance even when stored in a high-temperature environment or subjected to repeated charging and discharging cycles, while suppressing gas generation and minimizing changes in volumes.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are a schematic plan view and a cross-sectional view of a lithium secondary battery according to exemplary embodiments, respectively.

### DETAILED DESCRIPTION OF THE INVENTION

According to the embodiments of the present disclosure, an electrolyte for a lithium secondary battery which includes a phosphate-based additive and halogenated benzene is provided. In addition, a lithium secondary battery having improved high-temperature storage characteristics and high-temperature lifespan characteristics by including the electrolyte is provided.

### <Electrolyte for a Lithium Secondary Battery>

The electrolyte for a lithium secondary battery (hereinafter, may be abbreviated as an electrolyte) according to the exemplary embodiments of the present disclosure may include a lithium salt, an organic solvent, a phosphate-based additive and halogenated benzene.

In the exemplary embodiment, the organic solvent may be used as a balance or excess excluding solid contents such as the lithium salt, the phosphate-based additive, the halogenated benzene, an auxiliary additive, etc. In some embodiments, a content of the organic solvent may be 90% by weight (“wt %”) to 96 wt % based on a total weight of the electrolyte.

The organic solvent may include an organic compound which provides sufficient solubility for the lithium salt, the phosphate-based additive, the halogenated benzene, the auxiliary additive, etc., and does not have reactivity with the components of the lithium secondary battery. In some embodiments, a non-aqueous organic solvent is used, and the electrolyte may be provided as the non-aqueous electrolyte.

In some embodiments, the organic solvent may include a carbonate solvent, an ester solvent, an ether solvent, a ketone solvent, an alcohol solvent, an aprotic solvent, etc. These may be used alone or in combination of two or more thereof.

Examples of the carbonate solvent may include dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), fluoroethylene carbonate (FEC), butylene carbonate and the like.

Examples of the ester solvent may include methyl acetate (MA), ethyl acetate (EA), n-propyl acetate (n-PA), 1,1-dimethylethyl acetate (DMEA), methyl propionate (MP), ethyl propionate (EP), γ-butyrolacton (GBL), decanolide, valerolactone, mevalonolactone, caprolactone and the like.

Examples of the ether organic solvent may include dibutyl ether, tetraethylene glycol dimethyl ether (TEGDME), diethylene glycol dimethyl ether (DEGDME), dimethoxy ethane, 2-methyltetrahydrofuran, tetrahydrofuran and the like.

Examples of the ketone solvent may include cyclohexanone and the like. Examples of the alcohol solvent may include ethyl alcohol, isopropyl alcohol and the like.

Examples of the aprotic solvent may include a nitrile solvent, an amide solvent such as dimethyl formamide (DMF), etc., a dioxolane solvent such as 1,3-dioxolane, etc., a sulfolane solvent and the like.

In one embodiment, the carbonate solvent may be used as the organic solvent. For example, the organic solvent may include ethylene carbonate (EC), ethyl methyl carbonate (EMC), dimethyl carbonate (DMC), diethyl carbonate (DEC), or a combination thereof.

In one embodiment, a combination of at least two or more of ethylene carbonate (EC), ethyl methyl carbonate (EMC), dimethyl carbonate (DMC) and diethyl carbonate (DEC) may be used as the organic solvent.

According to exemplary embodiments, the lithium salt may include one or more lithium salt compounds. For example, the lithium salt may be represented as Li⁺X⁻; and non-limiting examples of an anion (X⁻) of the lithium salt may include PF₆⁻, F⁻, Cl⁻; Br⁻, I⁻, NO₃⁻, N(CN)₂⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻; BF₄⁻; B(C₂O₄)₂⁻, BF₂(C₂O₄)⁻, B(C₃H₂O₄)₂⁻, BF₂(C₃H₂O₄)⁻, B(C₃HO₄F)₂⁻, B(C₃F₂O₄)₂⁻, etc. These may be used alone or in combination of two or more thereof as the lithium salt.

In one embodiment, a concentration of the lithium salt in the electrolyte may be 0.01 M to 2 M, or 0.5 M to 1.5 M. Within the above range, the transfer of lithium ions and/or electrons may be promoted during charging and discharging of the lithium secondary battery, thereby securing improved capacity.

In exemplary embodiments, the electrolyte may include a phosphate-based additive. The phosphate-based additive may improve the flame retardancy of the electrolyte and its stability at a high temperature, thereby enhancing the high-temperature lifespan characteristics and high-temperature storage characteristics of the lithium secondary battery.

The phosphate-based additive includes a compound represented by Formula 1 below.

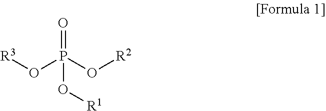

In Formula 1 above, R¹ to R³ may each independently be a C6 to C18 aryl group, a C6 to C18 halogenated aryl group, a C1 to C10 alkyl group, a C1 to C10 halogenated alkyl group, or a C2 to C10 alkenyl group.

As used herein, the term “aryl group” refers to a group including at least one aromatic ring, and may include, for example, a phenyl group, a naphthyl group, an anthracene group, etc. In some embodiments, the C6 to C18 aryl group may not include a biphenyl group.

As used herein, the term “alkyl group” refers to a chain-type saturated hydrocarbon, and may include a linear or branched alkyl group. For example, the C1 to C10 alkyl group may include a C1 to C10 linear alkyl group and a C3 to C10 branched alkyl group.

As used herein, the “halogenated” may mean that at least one of hydrogen atoms bonded to the carbon of an alkyl group or an aryl group is substituted with a halogen atom such as Cl, Br, F, I, etc.

As used herein, the term “alkenyl group” may mean a chain-type unsaturated hydrocarbon group that includes a carbon-carbon double bond in the middle or end of the chain.

The terms “alkyl group,” “cycloalkyl group,” “alkenyl group,” and “aryl group” as used herein may comprehensively refer to a substituted or unsubstituted group.

For example, the alkyl group, cycloalkyl group, alkenyl group and aryl group may each include a substituent which substitutes at least one of the hydrogen atoms bonded to the carbon.

Non-limiting examples of the substituent may include functional groups such as halogen, hydroxyl group, carboxyl group, amine group, amide group, cyano group, thiol group, sulfonic acid group, etc.

In exemplary embodiments, R¹ to R³ may each independently be a C6 to C18 aryl group such as a phenyl group, a naphthyl group, an anthracene group, etc.; a C6 to C18 halogenated aryl group such as a fluorophenyl group, a difluorophenyl group, a trifluorophenyl group, a chlorophenyl group, a dichlorophenyl group, a trichlorophenyl group, a fluoronaphthyl group, etc.; a C1 to C10 alkyl group such as a methyl group, an ethyl group, an n-propyl group, an isopropyl group, an n-butyl group, an isobutyl group, an n-pentyl group, a neopentyl group, an isopentyl group, etc.; a C1 to C10 halogenated alkyl group such as a fluoromethyl group, a difluoromethyl group, a trifluoromethyl group, a 2-fluoroethyl group, a 2,2-difluoroethyl group, a 2,2,2-trifluoroethyl group, a 3-fluoropropyl group, a 3,3-difluoropropyl group, a 3,3,3-trifluoropropyl group, etc.; or a C2 to C10 alkenyl group such as a vinyl group, a 1-propenyl group, a 2-propenyl group, an isopropenyl group, a 1-butenyl group, a 2-butenyl group, a 3-butenyl group, an isobutenyl group, a 2-methyl-2-butenyl group.

In Formula 1 above, R¹ to R³ may be the same as each other. In some embodiments, R¹ to R³ may be C6 to C18 halogenated aryl groups or C1 to C10 halogenated alkyl groups and may be the same as each other. For example, R¹ to R³ may each be a 2,2,2-trifluoroethyl group.

According to exemplary embodiments, in Formula 1 above, when at least one of R¹ to R³ is a C6 to C18 aryl group, at least one of R¹ and R² may not be the same as (i.e., may be different from) R³. For example, when R¹ is a phenyl group, R² and R³ may not be a phenyl group, or R² may be a phenyl group and R³ may not be a phenyl group.

According to exemplary embodiments, in Formula 1 above, R¹ and R² may each independently be a C6 to C18 aryl group, a C6 to C18 halogenated aryl group or a C1 to C5 halogenated alkyl group, and R³ may be a C6 to C18 halogenated aryl group or a C1 to C5 halogenated alkyl group. For example, R¹ and R² may each be a phenyl group, and R³ may be a 2,2,2-trifluoroethyl group.

In Formula 1 above, at least one of R¹ and R² may be different from R³. For example, in Formula 1 above, R¹ and R² may be the same as each other and may be different from R³, respectively.

For example, R¹ and R² may be C1 to C10 alkyl groups or C2 to C10 alkenyl groups and may be the same as each other, and R³ may be a C6 to C18 aryl group, a C6 to C18 halogenated aryl group, or a C1 to C10 halogenated alkyl group, and may be different from R¹ and R².

For example, R¹ to R³ may be C6 to C18 aryl groups, and R¹ and R² may be the same as each other and may be different from R³, respectively. For example, R¹ and R² may be phenyl groups, and R³ may be a naphthyl group.

For example, R¹ and R² may be C6 to C18 aryl groups and may be the same as each other, and R³ may be a halogenated aryl group having a C6 to C18 and may be different from each of R¹ and R². For example, R¹ and R² may be a phenyl group, and R³ may be a fluorophenyl group.

For example, R¹ and R² may be C6 to C18 halogenated aryl groups and may be the same as each other, and R³ may be a C6 to C18 aryl group and may be different from each of R¹ and R². For example, R¹ and R² may be a fluorophenyl group, and R³ may be a phenyl group.

For example, R¹ and R² may be C6 to C18 aryl groups and may be the same as each other, and R³ may be a halogenated aryl group having a C6 to C18 and may be different from each of R¹ and R². For example, R¹ and R² may be phenyl groups, and R³ may be a fluorophenyl group.

For example, R¹ to R³ may be C6 to C18 halogenated aryl groups, and R¹ and R² may be the same as each other and may be different from R³, respectively. For example, R¹ and R² may be a fluorophenyl group, and R³ may be a difluorophenyl group.

For example, R¹ and R² may be C1 to C10 alkyl groups and may be the same as each other, and R³ may be a C6 to C18 aryl group and may be different from each of R¹ and R². For example, R¹ and R² may be methyl groups, and R³ may be a phenyl group.

For example, R¹ and R² may be C2 to C10 alkenyl groups and may be the same as each other, and R³ may be a C6 to C18 aryl group and may be different from each of R¹ and R². For example, R¹ and R² may be vinyl groups, and R³ may be a phenyl group.

For example, R¹ and R² may be C1 to C10 halogenated alkyl groups and may be the same as each other, and R³ is a C6 to C18 aryl group and may be different from each of R¹ and R². For example, R¹ and R² may be a 2,2,2-trifluoroethyl group, and R³ may be a phenyl group.

For example, R¹ to R³ may be C1 to C10 halogenated alkyl groups, and R¹ and R² may be the same as each other and may be different from R³, respectively. For example, R¹ and R² may be 2,2,2-trifluoroethyl groups, and R³ may be a 3,3,3-trifluoropropyl group.

In some embodiments, in Formula 1 above, R¹ and R³ may be the same as each other and may be different from R², respectively, or R¹, R² and R³ may be different from each other.

According to exemplary embodiments, in Formula 1 above, R¹ may be a C6 to C18 aryl group or a C6 to C18 halogenated aryl group, and R² may be a C1 to C5 halogenated alkyl group.

According to exemplary embodiments, in Formula 1 above, R¹ may be a phenyl group or a fluorophenyl group, R² may be a trifluoromethyl group, a 2,2,2-trifluoroethyl group or a 3,3,3-trifluoropropyl group, and R³ may be a phenyl group, a fluorophenyl group, a trifluoromethyl group, a 2,2,2-trifluoroethyl group or a 3,3,3-trifluoropropyl group.

For example, in Formula 1 above, R¹ may be a phenyl group, R² may be a 2,2,2-trifluoroethyl group, and R³ may be a phenyl group or a 2,2,2-trifluoroethyl group.

According to exemplary embodiments, the phosphate-based additive may include at least one selected from the group consisting of tris(2,2,2-trifluoroethyl) phosphate, tris(3,3,3-trifluoropropyl) phosphate, bis(2,2,2-trifluoroethyl) (3,3,3-trifluoropropyl) phosphate, diphenyl(2,2,2-trifluoroethyl) phosphate, and bis(2,2,2-trifluoroethyl) phenyl phosphate.

The electrolyte according to exemplary embodiments may include the phosphate-based additive including an aryl group or a halogenated alkyl group. The phosphate-based additive may increase the flame retardancy of the electrolyte, and may improve the stability of the electrolyte and the battery including the electrolyte at a high temperature.

According to exemplary embodiments, the compound represented by Formula 1 above may be included in a content of 50 wt % or more and 100 wt % or less, 60 wt % or more and 100 wt % or less, 70 wt % or more and 100 wt % or less, 80 wt % or more and 100 wt % or less, or 90 wt % or more and 100 wt % or less based on the total phosphate-based additive weight. In some embodiments, the phosphate-based additive may be substantially composed of the compound represented by Formula 1 above.

According to exemplary embodiments, the phosphate-based additive may include two or more compounds in which at least one of R¹, R² and R³ in the compound represented by Formula 1 is different from the others. For example, the phosphate-based additive may include a mixture of a compound in which R¹ and R² in Formula 1 are 2,2,2-trifluoroethyl groups and R³ is a phenyl group, and a compound in which R¹ and R² in Formula 1 are phenyl groups and R³ is a 2,2,2-trifluoroethyl group.

According to exemplary embodiments, the content of the phosphate-based additive may be 1 wt % to 15 wt % based on the total weight of the electrolyte. In some embodiments, the content of the phosphate-based additive may be 1 wt % or more, 2 wt % or more, 3 wt % or more, 4 wt % or more, 5 wt % or more, or 6 wt % or more, and 15 wt % or less, 14 wt % or less, 13 wt % or less, 12 wt % or less, 11 wt % or less, 10 wt % or less, or 9 wt % or less based on the total weight of the electrolyte.

Within the above range, an excessive side reaction of the electrolyte at a high temperature may be suppressed while securing the flame retardancy of the electrolyte.

In exemplary embodiments, the electrolyte may include halogenated benzene. The halogenated benzene may further improve the flame retardancy of the electrolyte together with the phosphate-based additive.

The halogenated benzene may form halogen radicals in a high-temperature environment. The halogen radicals may capture unstable by-products formed when the electrolyte decomposes in a high-temperature environment or when electrolyte components cause side reactions with electrode active materials, etc. Accordingly, the thermal stability and flame retardancy of the electrolyte may be improved.

When the electrolyte includes only the phosphate-based additive, the performance of the battery may deteriorate rapidly. The electrolyte according to exemplary embodiments may include the phosphate-based additive and the halogenated benzene together, thereby alleviating the performance deterioration of the battery.

According to exemplary embodiments, the halogenated benzene may have a structure in which at least one of six hydrogen atoms bonded to each carbon is substituted with a halogen atom. The halogen atom may include fluorine (F), chlorine (Cl), bromine (Br), iodine (I) and the like.

The halogenated benzene may include fluorinated benzene. The fluorinated benzene may further improve the flame retardancy of the electrolyte.

According to exemplary embodiments, the halogenated benzene may include 1 to 6 fluorine atoms bonded to a benzene ring. According to some embodiments, the halogenated benzene may include 1 to 3 fluorine atoms or 1 fluorine atom bonded to the benzene ring.

According to exemplary embodiments, the halogenated benzene may include at least one selected from the group consisting of fluorobenzene, difluorobenzene and trifluorobenzene. In some embodiments, the halogenated benzene may include fluorobenzene.

According to exemplary embodiments, the content of the halogenated benzene may be 1 wt % to 20 wt % based on the total weight of the electrolyte. The content of the halogenated benzene may be 1 wt % or more, 3 wt % or more, 5 wt % or more, 7 wt % or more, or 10 wt % or more, and 20 wt % or less, 18 wt % or less, 16 wt % or less, 14 wt % or less, or 12 wt % or less based on the total weight of the electrolyte.

Within the above range, the capacity retention rate of the battery may be improved during high-temperature storage, thereby suppressing gas generation while securing thermal stability, and thus reducing the thickness increase rate of the battery. In addition, a battery with improved initial cell performance may be implemented due to the increased the initial capacity.

According to some embodiments, when increasing the content of the halogenated benzene within the above range, the capacity retention rate of the battery, after being stored at a high temperature or subjected to repeated charging and discharging cycles, may be further improved, and an amount of gas generated inside the battery may be reduced. In addition, when decreasing the content of the halogenated benzene within the above range, internal resistance characteristics of the battery may be further improved. Accordingly, the content of the halogenated benzene may be appropriately adjusted within the above range.

According to exemplary embodiments, a ratio of the content of the halogenated benzene to the content of the phosphate-based additive in the total weight of the electrolyte may be 0.5 to 4. According to some embodiments, the ratio of the content of the halogenated benzene to the content of the phosphate-based additive in the total weight of the electrolyte may be 1 to 3, 0.5 to 2.5, 1.5 to 3.5, or 1.5 to 2.5.

Within the above range, the content ratio of the phosphate-based additive and the halogenated benzene is appropriately maintained, such that the capacity retention rate of the battery may be further increased during high-temperature storage. In addition, the decomposition and side reaction of the electrolyte may be suppressed, thereby reducing the amount of gas generated inside the battery, and thus reducing the thickness increase rate of the battery during high-temperature storage.

In exemplary embodiments, the electrolyte may further include an auxiliary additive. The auxiliary additive may be included in an amount of 0.01 to 5 wt %, for example, 0.1 to 4 wt % based on the total weight of the electrolyte.

For example, the auxiliary additive may include an unsaturated cyclic carbonate compound, a fluorine-substituted cyclic carbonate compound, a sultone compound, a cyclic sulfate compound, a fluorine-substituted phosphate compound, an oxalato phosphate compound and the like.

The unsaturated cyclic carbonate compound may include vinyl ethylene carbonate (VEC), vinylene carbonate (VC), etc.

The fluorine-substituted cyclic carbonate compound may include fluoroethylene carbonate (FEC).

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The fluorine-substituted phosphate compound may include lithium difluorophosphate (LiPO₂F₂), etc.

The oxalato phosphate compound may include lithium difluorobis(oxalato) phosphate, etc.

These may be used alone or in combination of two or more thereof.

By adding the auxiliary additive, the durability and stability of the electrode may be further improved. The auxiliary additive may be included in an appropriate amount within a range that does not hinder the movement of lithium ions in the electrolyte.

### <Lithium Secondary Battery>

The embodiments of the present disclosure provide a lithium secondary battery including the above-described electrolyte.

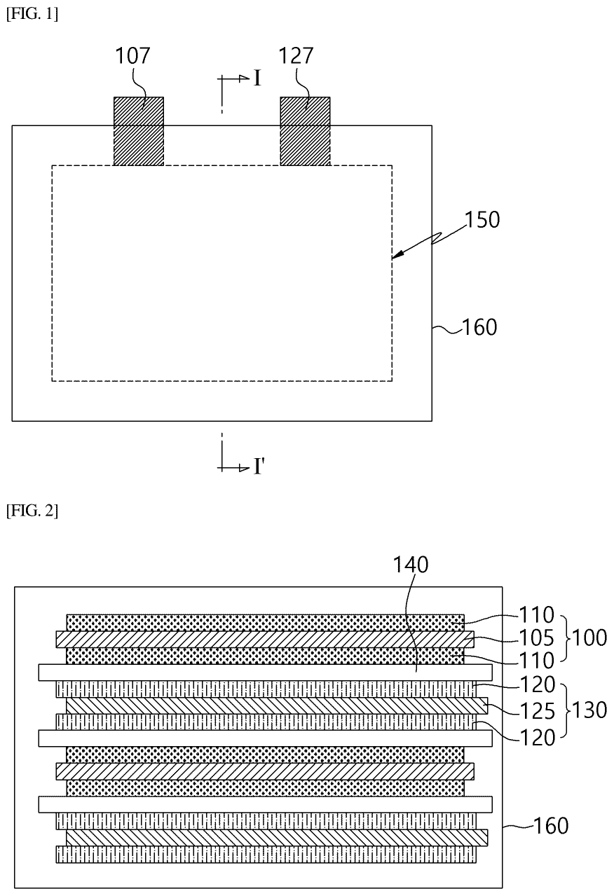

FIGS. 1 and 2 are a schematic plan view and a cross-sectional view illustrating a lithium secondary battery according to exemplary embodiments, respectively. For example, FIG. 2 is a cross-sectional view taken on line I-I′ in FIG. 1.

Referring to FIGS. 1 and 2, the lithium secondary battery may include an electrode assembly including a cathode 100, an anode 130 and a separation membrane 140 interposed between the cathode and the anode.

The electrode assembly may be housed in a case 160 together with the electrolyte to be impregnated therein by the electrolyte.

The cathode 100 may include a cathode active material layer 110 formed by applying a cathode active material to a cathode current collector 105. The cathode active material may include a compound capable of reversibly intercalating and deintercalating lithium ions.

In exemplary embodiments, the cathode active material may include a lithium-transition metal oxide. For example, the lithium-transition metal oxide includes nickel (Ni), and may further include at least one of cobalt (Co) and manganese (Mn).

For example, the lithium-transition metal oxide may be represented by Formula 2 below.

Li₁₊ₐNi_{1-(x+y)} CoₓM_{y}O₂ [Formula 2]

In Formula 2 above, a, x and y may satisfy −0.05≤a≤0.2, 0.01≤x≤0.3, 0.01≤y≤0.3, and M may be one or more elements selected from Mn, Mg, Sr, Ba, B, Al, Si, Ti, Zr, or W.

As indicated in Formula 2 above, a lithium-transition metal compound may include Ni in the highest content or molar ratio among Ni, Co and M. Ni may actually function as a metal related to output and/or capacity of the lithium secondary battery, and as Ni is included in the highest amount among transition metals, it is possible to implement a high capacity, high output lithium secondary battery.

In one embodiment, in Formula 2, x and y may satisfy 0.01≤x≤0.2, 0.01≤y≤0.2. In one embodiment, the molar ratio of Ni may be 0.7 or more or 0.8 or more.

When the content of Ni in the cathode active material or the lithium-transition metal oxide is increased, relatively chemical stability, for example, high-temperature storage stability of the secondary battery may be deteriorated. In addition, due to surface damage of the cathode active material or side reaction with the electrolyte due to the repeated charging/discharging, sufficient high output/high capacity characteristics according to the high content of Ni may not be implemented.

However, as described above, the fluorine additive may be bonded to Ni on the surface of the cathode active material or lithium-transition metal oxide through a coordinate bond or chemical interaction to provide passivation of the cathode active material. Therefore, the high output/high capacity characteristics through the high content of Ni may be substantially and uniformly maintained for a long time even in a high temperature environment.

A slurry may be prepared by mixing and stirring the cathode active material with a binder, a conductive material and/or a dispersant in a solvent. The slurry may be applied to the cathode current collector 105, followed by compressing and drying to prepare the cathode 100.

The cathode current collector 105 may include, for example, stainless steel, nickel, aluminum, titanium, copper, or an alloy thereof. In one embodiment, the cathode current collector 105 may include aluminum or an aluminum alloy.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a cathode binder. In this case, an amount of the binder for forming the cathode active material layer may be reduced and an amount of the cathode active material or lithium metal oxide particles may be relatively increased. Thereby, the output and capacity of the secondary battery may be improved.

The conductive material may be included to facilitate the movement of electrons between the active material particles. For example, the conductive material may include a carbon-based conductive material such as graphite, carbon black, graphene, or carbon nanotubes and/or a metal-based conductive material such as tin, tin oxide, titanium oxide, or a perovskite material such as LaSrCoO₃, and LaSrMnO₃, etc.

The anode 130 may include an anode current collector 125 and an anode active material layer 120 formed by coating the anode current collector 125 with an anode active material.

The anode active material useable in the present invention may include any material known in the related art, so long as it can intercalate and deintercalate lithium ions, without particular limitation thereof. For example, carbon-based materials such as crystalline carbon, amorphous carbon, carbon composite, carbon fiber, etc.; a lithium alloy; a silicon (Si) compound or tin, etc. may be used. Examples of the amorphous carbon may include hard carbon, cokes, mesocarbon microbead (MCMB), mesophase pitch-based carbon fiber (MPCF) or the like.

Examples of the crystalline carbon may include graphite-based carbon such as natural graphite, artificial graphite, graphite cokes, graphite MCMB, graphite MPCF or the like. Other elements included in the lithium alloy may include, for example, aluminum, zinc, bismuth, cadmium, antimony, silicone, lead, tin, gallium or indium, etc.

The silicon compound may include, for example, silicon, silicon oxide or a silicon-carbon composite compound such as silicon carbide (SiC).

For example, a form of slurry may be prepared by mixing the anode active material with a binder, a conductive material, thickener, and the like in a solvent, followed by stirring the same. The slurry may be applied to at least one surface of the anode current collector 125, followed by compressing and drying to prepare the anode 130.

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fiber having a high melting point, polyethylene terephthalate fiber or the like.

In some embodiments, the anode 130 may have an area (e.g., a contact area with the separation membrane 140) and/or volume larger than those/that of the cathode 100. Thereby, lithium ions generated from the cathode 100 may smoothly move to the anode 130 without being precipitated in the middle, for example.

According to exemplary embodiments, an electrode cell is defined by the cathode 100, the anode 130 and the separation membrane 140, and a plurality of electrode cells are laminated to form, for example, a jelly roll type electrode assembly 150. For example, the electrode assembly 150 may be formed by winding, lamination, folding, and the like of the separation membrane 140.

The electrode assembly 150 may be housed in the case 160 together with the non-aqueous electrolyte according to the above-described exemplary embodiments to define the lithium secondary battery. According to exemplary embodiments, the non-aqueous electrolyte may be used as the electrolyte.

As shown in FIG. 1, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) extending or exposed to an outside of the case 160.

The lithium secondary battery may be manufactured, for example, in a cylindrical shape using a can, a square shape, a pouch shape or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Synthesis Example 1

Tris(2,2,2-trifluoroethyl) phosphate was synthesized as a compound represented by Formula 1-1.

Specifically, 200 ml of dichloromethane was quantified and put into a 500 ml round-bottom flask, then 20 g (200 mmol) of 2,2,2-trifluoroethanol and 14.0 g (206 mmol) of imidazole were added thereto and mixed. After violently stirring the mixture for 1.5 hours while maintaining 0° C. in a nitrogen environment, 9.89 g (64 mmol) of phosphorous oxychloride (POCl₃) was slowly added dropwise to the reactor. The mixture was further stirred for 21 hours at room temperature while maintaining the nitrogen environment. Thereafter, 200 ml of a 10 wt % NaOH aqueous solution was mixed to quench the remaining starting material, and an organic solvent layer was separated. After extracting the obtained organic solvent layer by adding 200 ml of water three times, the organic solvent layer was vacuum-dried to remove the solvent and moisture. The obtained solution was purified using a silica column to obtain 11.98 g (yield 54%) of the compound represented by Formula 1-1.

1H-NMR chemical shift (500 MHZ, Acetone-d6), δ: 4.26-4.15 (m, 6H)

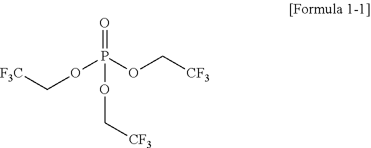 [SMILES: O=P(OCC(F)(F)F)(OCC(F)(F)F)OCC(F)(F)F]

### Synthesis Example 2

Phenyl bis(2,2,2-trifluoroethyl) phosphate was synthesized as a compound represented by Formula 1-2.

Specifically, 100 ml of dichloromethane was quantified and put into a 500 ml round-bottom flask, followed by cooling to 0° C., and 10 g (47.4 mmol) of phenyl dichlorophosphate and 12 g (118 mmol) of triethylamine were added thereto and mixed. Then, 10.4 g (104.3 mmol) of 2,2,2-trifluoroethanol was slowly added thereto for 20 minutes while maintaining 0° C. in a nitrogen environment, and then the mixture was stirred at room temperature for 24 hours. Thereafter, the organic layer was extracted by adding an aqueous hydrochloric acid solution once and distilled water twice, and the organic solvent layer was vacuum-dried to remove the solvent and moisture. The obtained solution was purified using a silica column to obtain 11.7 g (yield 73%) of the compound represented by Formula 1-2.

1H-NMR chemical shift (500 MHZ, Acetone-d6), δ: 7.46-7.48 (m, 2H), 7.28-7.33 (m, 3H), 4.79-4.85 (m, 4H)

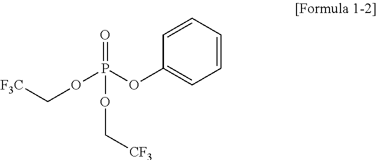 [SMILES: O=P(OCC(F)(F)F)(OCC(F)(F)F)Oc1ccccc1]

### Synthesis Example 3

Diphenyl 2,2,2-trifluoroethyl phosphate was synthesized as a compound represented by Formula 1-3.

100 ml of dichloromethane was quantified and put into in a 500 ml round-bottom flask, followed by cooling to 0° C., and 10 g (37.2 mmol) of diphenyl chlorophosphate and 8.3 g (81.8 mmol) of triethylamine were added thereto and mixed. Then, 7.7 g (76.3 mmol) of 2,2,2-trifluoroethanol was slowly added thereto for 20 minutes while maintaining 0° C. in a nitrogen environment, and then the mixture was stirred at room temperature for 24 hours. Thereafter, the organic layer was extracted by adding an aqueous hydrochloric acid solution once and distilled water twice, and the organic solvent layer was vacuum-dried to remove the solvent and moisture. The obtained solution was purified using a silica column to obtain 9.89 g (yield 80%) of the compound represented by Formula 1-3.

1H-NMR chemical shift (500 MHZ, Acetone-d6), δ: 7.44-7.48 (m, 4H), 7.28-7.37 (m, 6H), 4.88-4.91 (m, 2H)

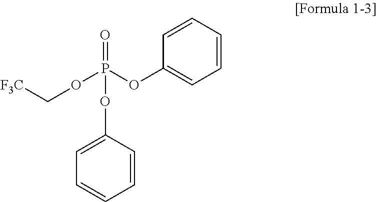 [SMILES: O=P(OCC(F)(F)F)(Oc1ccccc1)Oc1ccccc1]

### Example 1

### (1) Preparation of Electrolyte

A 1 M LiPF₆ solution (a mixed solvent of ethylene carbonate (EC) and ethyl methyl carbonate (EMC), volume ratio EC:EMC=25:75) was prepared. 1 wt % of fluoroethylene carbonate (FEC), 0.5 wt % of 1,3-propane sultone (PS) and 0.3 wt % of 1,3-propene sultone (PRS) based on the total weight of the electrolyte were added to the LiPF₆ solution, and 5 wt % of tris(2,2,2-trifluoroethyl) phosphate prepared in Synthesis Example 1 and 5 wt % of fluorobenzene (Sigma Aldrich) were added.

### (2) Manufacturing of Lithium Secondary Battery Sample

A slurry was prepared by mixing the cathode active material of Li [Ni_{0.8}Co_{0.1}Mn_{0.1}]O₂, carbon black as a conductive agent, and polyvinylidene fluoride (PVdF) as a binder at a weight ratio of 92:5:3. The slurry was uniformly applied to an aluminum foil having a thickness of 15 μm, vacuum-dried and pressed at 130° C. to prepare a cathode for a lithium secondary battery.

An anode slurry was prepared by mixing 95 wt % of an anode active material in which artificial graphite and natural graphite are mixed in a weight ratio of 7:3, 1 wt % of Super-P as a conductive agent, 2 wt % of styrene-butadiene rubber (SBR) as a binder, and 2 wt % of carboxymethyl cellulose (CMC) as a thickener. The anode slurry was uniformly applied to a copper foil having a thickness of 15 μm, followed by drying and pressing the same to prepare an anode.

The anode slurry was uniformly applied to a region of the copper foil (thickness 15 μm) having a protrusion part (anode tab) on one side except for the protrusion part, followed by drying and pressing the same to prepare an anode.

The cathode and the anode prepared as described above were cut into a predetermined size and laminated, and a separator (polyethylene, thickness 20 μm) was interposed between the cathode and the anode to form an electrode assembly, and then tab parts of the cathode and the anode were welded, respectively.

The electrode assembly was put into a pouch, followed by sealing three sides of the pouch except for an electrolyte injection side. At this time, a portion having the electrode tab was included in the sealing part. After injecting the electrolyte prepared in (1) above through the electrolyte injection side except for the sealing part, and the remaining side was also sealed, followed by impregnation for 12 hours or more to manufacture a rechargeable lithium battery sample.

### Example 2

An electrolyte and a lithium secondary battery sample were manufactured in the same manner as in Example 1, except that phenyl bis(2,2,2-trifluoroethyl) phosphate prepared in Synthesis Example 2 was used instead of the compound prepared in Synthesis Example 1 as the phosphate-based additive.

### Example 3

An electrolyte and a lithium secondary battery sample were manufactured in the same manner as in Example 1, except that diphenyl 2,2,2-trifluoroethyl phosphate prepared in Synthesis Example 3 was used instead of the compound prepared in Synthesis Example 1 as the phosphate-based additive.

### Example 4

An electrolyte and a lithium secondary battery sample were manufactured in the same manner as in Example 1, except that difluorobenzene was used instead of fluorobenzene.

### Example 5

An electrolyte and a lithium secondary battery sample were manufactured in the same manner as in Example 1, except that the content of fluorobenzene was set to 10 wt %.

### Example 6

An electrolyte and a lithium secondary battery sample were manufactured in the same manner as in Example 1, except that the content of fluorobenzene was set to 15 wt %.

### Example 7

An electrolyte and a lithium secondary battery sample were manufactured in the same manner as in Example 1, except that the content of phosphate was 10 wt % and the content of fluorobenzene was set to 10 wt %.

### Comparative Example 1

An electrolyte and a lithium secondary battery sample were manufactured in the same manner as in Example 1, except that fluorobenzene was not used.

### Comparative Example 2

An electrolyte and a lithium secondary battery sample were manufactured in the same manner as in Example 1, except that fluorobenzene was not used and the content of phosphate was set to 10 wt %.

### Comparative Example 3

An electrolyte and a lithium secondary battery sample were manufactured in the same manner as in Example 1, except that fluorobenzene was not used and the phosphate content was set to 20 wt %.

### Comparative Example 4

An electrolyte and a lithium secondary battery sample were manufactured in the same manner as in Example 1, except that the compound prepared in Synthesis Example 1 was not used.

### Comparative Example 5

An electrolyte and a lithium secondary battery sample were manufactured in the same manner as in Example 1, except that triphenyl phosphate was used instead of the compound prepared in Synthesis Example 1 as the phosphate-based additive.

### Comparative Example 6

An electrolyte and a lithium secondary battery sample were manufactured in the same manner as in Example 7, except that triphenyl phosphate was used instead of the compound prepared in Synthesis Example 1 as the phosphate-based additive.

### Comparative Example 7

An electrolyte and a lithium secondary battery sample were manufactured in the same manner as in Example 1, except that the compound prepared in Synthesis Example 1 and fluorobenzene were not used.

The electrolyte compositions of the examples and comparative examples are shown in Table 1 below. The type of the phosphate-based additive is described by the number of the synthesis example, and the content is described in weight % based on the total weight of the electrolyte. In Table 1 below, TPP means triphenyl phosphate.

TABLE 1

| | Phosphate-based additive | | Halogenated benzene | |
|---|---|---|---|---|
| | Type | Content (wt %) | Type | Content (wt %) |
| Example 1 | Synthetic Example 1 | 5 | Fluorobenzene | 5 |
| Example 2 | Synthetic Example 2 | 5 | Fluorobenzene | 5 |
| Example 3 | Synthetic Example 3 | 5 | Fluorobenzene | 5 |
| Example 4 | Synthetic Example 1 | 5 | Difluorobenzene | 5 |
| Example 5 | Synthetic Example 1 | 5 | Fluorobenzene | 10 |
| Example 6 | Synthetic Example 1 | 5 | Fluorobenzene | 15 |
| Example 7 | Synthetic Example 1 | 10 | Fluorobenzene | 10 |
| Comparative | Synthetic Example 1 | 5 | — | — |
| Example 1 | | | | |
| Comparative | Synthetic Example 1 | 10 | — | — |
| Example 2 | | | | |
| Comparative | Synthetic Example 1 | 20 | — | — |
| Example 3 | | | | |
| Comparative | — | — | Fluorobenzene | 5 |
| Example 4 | | | | |
| Comparative | TPP | 5 | Fluorobenzene | 5 |
| Example 5 | | | | |
| Comparative | TPP | 10 | Fluorobenzene | 10 |
| Example 6 | | | | |
| Comparative | — | — | — | — |
| Example 7 | | | | |

### Experimental Example

The characteristics of the battery samples were evaluated according to the following experimental method, and results thereof are shown in Tables 2 and 3 below.

### (1) Evaluation of Initial Performance

### 1) DCIR Measurement

At 60% point of state-of-charging (SOC), when increasing the C-rate to 0.2C, 0.5C, 1.0C, 1.5C, 2.0C, 2.5C and 3.0C, and performing charging and discharging on the secondary battery samples of the examples and comparative examples at the corresponding C-rate for 10 seconds, terminal points of the voltage were composed with an equation of a straight line and a slope thereof was adopted as an initial DCIR.

### 2) Measurement of Capacity

Each of the secondary battery samples of the examples and comparative examples was subjected to 0.5C-rate CC/CV charging (4.2V, 0.05C cut-off) at 25° C., followed by 0.5C-rate CC discharging (2.7V cut-off), and then the discharge capacity was measured. This process was repeated three times, and an average value of the discharge capacities was calculated as an initial capacity.

### (2) Evaluation of High-Temperature Storage Characteristics

### 1) DCIR Measurement

Each of the secondary battery samples of the examples and comparative examples was stored at a high temperature of 60° C. for 12 weeks. After the secondary battery samples of the examples and comparative examples were stored at a high temperature, DCIR was measured as described in (1)-1).

### 2) Measurement of Capacity Retention Rate

After the secondary battery samples of the examples and comparative examples were stored at a high temperature as described in (2)-1), 0.5C-rate CC discharging (2.7V cut-off) was performed to measure the discharge capacities thereof.

The capacity retention rate was calculated by converting the discharge capacity measured after high temperature storage into a percentage relative to the initial capacity measured in 1-1) using the following equation.

$$Capacity retention rate ( \% ) = ( Discharge capacity after high - temperature storage / Initial capacity ) \times 100$$

### 3) Measurement of Thickness Increase Rate

For each of the secondary battery samples of the examples and comparative examples before high-temperature storage, the thickness at the central point was measured, and after the secondary battery samples of the examples and comparative examples were stored at a high temperature as described in (2)-1), the thickness at the same point was measured again.

The thickness increase rate was calculated as a percentage of the battery thickness after high-temperature storage relative to the initial thickness.

$$Thickness increase rate ( \% ) = ( Battery thickness after high - temperature storage / Initial thickness ) \times 100$$

### (3) Evaluation of High-Temperature Lifespan Characteristics

### 1) DCIR Measurement

The lithium secondary battery samples of the examples and comparative examples underwent 500 repeated charge/discharge cycles, with each cycle consisting of charging to 96% SOC at a C-rate of 1.0C at a temperature of 45° C., followed by discharging to 2% SOC at a C-rate of 1.0C. After completing the repeated cycles, DCIR was measured in the same manner as described in (1)-1).

### 2) Measurement of Capacity Retention

For the samples, 500 charge/discharge cycles were repeated, with each cycle consisting of charging to 96% SOC at a C-rate of 1.0C at a temperature of 45° C., followed by discharging to 2% SOC at a C-rate of 1.0C.

In this case, the initial discharge capacity at the first cycle was measured, and the capacity retention rate of the high-temperature lifespan was determined by dividing the discharge capacity at the 500th cycle by the discharge capacity at the first cycle.

$$Capacity retention rate ( \% ) = ( Discharge capacity after high - temperature storage / Initial capacity ) \times 100$$

TABLE 2

| | | Example | | | | | | |
|---|---|---|---|---|---|---|---|---|
| Item | | 1 | 2 | 3 | 4 | 5 | 6 | 7 |
| Initial | DCIR | 44.4 | 43.2 | 45.1 | 44.1 | 45.5 | 48.7 | 49.8 |
| charac- | (mΩ) | | | | | | | |
| teristics | Capacity | 1791.1 | 1788 | 1790 | 1793 | 1775.7 | 1762.5 | 1748.0 |
| | (mAh) | | | | | | | |
| High- | DCIR | 45.8 | 45.3 | 47.7 | 48.9 | 47.4 | 49.8 | 50.4 |
| temper- | (mΩ) | | | | | | | |
| ature | Capacity | 91 | 91 | 93 | 92 | 93 | 96 | 95 |
| storage | retention | | | | | | | |
| charac- | rate (%) | | | | | | | |
| teristics | Thickness | 158 | 151 | 145 | 154 | 155.5 | 152 | 148 |
| | Increase | | | | | | | |
| | rate (%) | | | | | | | |
| High- | DCIR | 30.8 | 29.4 | 27.1 | 30.8 | 31.0 | 32.9 | 31.5 |
| temper- | (mΩ) | | | | | | | |
| ature | Capacity | 90 | 89 | 89 | 86 | 91 | 92 | 94 |
| lifespan | retention | | | | | | | |
| charac- | rate (%) | | | | | | | |
| teristics | | | | | | | | |

TABLE 3

| | | Comparative Example | | | | | | |
|---|---|---|---|---|---|---|---|---|
| Item | | 1 | 2 | 3 | 4 | 5 | 6 | 7 |
| Initial | DCIR | 45.3 | 51.6 | 60.2 | 42.0 | 47.9 | 51.5 | 41.5 |
| charac- | (mΩ) | | | | | | | |
| teristics | Capacity | 1778.3 | 1751.9 | 1711.5 | 1798.9 | 1785.9 | 1755.8 | 1790.3 |
| | (mAh) | | | | | | | |
| High- | DCIR | 43.7 | 52.9 | 63.5 | 48.1 | 52.3 | 55.3 | 43.3 |
| temper- | (mΩ) | | | | | | | |
| ature | Capacity | 90 | 89 | 81 | 87 | 91 | 89 | 93 |
| storage | retention | | | | | | | |
| charac- | rate (%) | | | | | | | |
| teristics | Thickness | 165 | 164 | 177 | 161.5 | 162 | 168 | 152 |
| | Increase | | | | | | | |
| | rate (%) | | | | | | | |
| High- | DCIR | 29.2 | 30.4 | 35.9 | 29.6 | 30.9 | 34.1 | 27.9 |
| temper- | (mΩ) | | | | | | | |
| ature | Capacity | 76 | 87 | 83 | 84 | 86 | 81 | 84 |
| lifespan | retention | | | | | | | |
| charac- | rate (%) | | | | | | | |
| teristics | | | | | | | | |

Referring to Tables 2 and 3 above, the lithium secondary batteries of the examples exhibit high initial capacity and low resistance. In addition, it can be confirmed that the lithium secondary batteries of the examples exhibit a small increase in resistance during high-temperature storage, a high capacity retention rate, and a low thickness increase rate, thereby ensuring that the cell performance does not significantly deteriorate. The lithium secondary batteries of the examples exhibit a small increase in resistance and a high capacity retention rate even during repeated charging and discharging at a high temperature, thereby also improving the high-temperature lifespan characteristics.

Referring to Tables 2 and 3 above, the lithium secondary batteries of Comparative Examples 1 to 3, which have electrolytes that do not include fluorobenzene, exhibited more deteriorated initial battery characteristics, high-temperature storage characteristics and high-temperature lifespan characteristics than the lithium secondary batteries of the examples.

The high-temperature storage characteristics of the lithium secondary battery of Comparative Example 4, which has an electrolyte that does not include phosphate-based additive, were more deteriorated than those of the lithium secondary batteries of the examples.

All evaluation characteristics of the lithium secondary batteries of Comparative Examples 5 and 6, which have electrolytes including triphenyl phosphate, were more deteriorated than those of the lithium secondary batteries of Examples 1 and 7, respectively.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. An electrolyte for a lithium secondary battery comprising:
a lithium salt, an organic solvent, a phosphate-based additive which comprises a compound represented by Formula 1 below, and halogenated benzene: 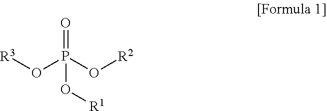
(in Formula 1 above, R¹ to R³ are each independently a C6 to C18 aryl group, a C6 to C18 halogenated aryl group, a C1 to C10 alkyl group, a C1 to C10 halogenated alkyl group, or a C2 to C10 alkenyl group, and
when at least one of R¹ to R³ is a C6 to C18 aryl group, at least one of R¹ and R² is not the same as R³).

2. The electrolyte for a lithium secondary battery according to claim 1, wherein in Formula 1 above, R¹ and R² are each independently a C6 to C18 aryl group, a C6 to C18 halogenated aryl group, or a C1 to C5 halogenated alkyl group, and R³ is a C6 to C18 halogenated aryl group or a C1 to C5 halogenated alkyl group.

3. The electrolyte for a lithium secondary battery according to claim 1, wherein the phosphate-based additive comprises at least one selected from the group consisting of tris(2,2,2-trifluoroethyl) phosphate, tris(3,3,3-trifluoropropyl) phosphate, bis(2,2,2-trifluoroethyl) (3,3,3-trifluoropropyl) phosphate, diphenyl(2,2,2-trifluoroethyl) phosphate, and bis(2,2,2-trifluoroethyl) phenyl phosphate.

4. The electrolyte for a lithium secondary battery according to claim 1, wherein the aryl group of C6 to C18 comprises a phenyl group, a naphthyl group or an anthracene group.

5. The electrolyte for a lithium secondary battery according to claim 1, wherein a content of the phosphate-based additive is 1% by weight to 15% by weight based on a total weight of the electrolyte.

6. The electrolyte for a lithium secondary battery according to claim 1, wherein the halogenated benzene includes 1 to 6 fluorine atoms bonded to a benzene ring.

7. The electrolyte for a lithium secondary battery according to claim 1, wherein the halogenated benzene comprises at least one selected from the group consisting of fluorobenzene, difluorobenzene and trifluorobenzene.

8. The electrolyte for a lithium secondary battery according to claim 1, wherein a content of the halogenated benzene is 1% by weight to 20% by weight based on the total weight of the electrolyte.

9. The electrolyte for a lithium secondary battery according to claim 1, wherein a ratio of the content of the halogenated benzene to the content of the phosphate-based additive in the total weight of the electrolyte is 0.5 to 4.

10. The electrolyte for a lithium secondary battery according to claim 1, wherein a ratio of the content of the halogenated benzene to the content of the phosphate-based additive in the total weight of the electrolyte is 1 to 3.

11. The electrolyte for a lithium secondary battery according to claim 1, wherein the electrolyte further comprises at least one auxiliary additive selected from the group consisting of a cyclic carbonate compound, a fluorine-substituted cyclic carbonate compound, a sultone compound, a cyclic sulfate compound, a fluorine-substituted phosphate compound, and an oxalato phosphate compound.

12. The electrolyte for a lithium secondary battery according to claim 11, wherein the content of the auxiliary additive is 0.01% by weight to 5% by weight based on the total weight of the electrolyte.

13. A lithium secondary battery comprising:
a case;
an electrode assembly which is housed in the case and comprises a cathode and an anode disposed to face the cathode; and
the electrolyte for a lithium secondary battery according to claim 1 housed in the case together with the electrode assembly.
